(19) United States
(12) Patent Application Publication
(10) Pub. No.: US 2026/0284778 A1
(43) Pub. Date: Sep. 24, 2026

(54) FRICTION STIR SPOT WELDING DEVICE AND METHOD

(71) Applicant: KAWASAKI JUKOGYO KABUSHIKI KAISHA, Kobe-shi, Hyogo (JP)

(72) Inventors: Naoki TAKEOKA, Kobe-shi (JP); Shuhei YOSHIKAWA, Kobe-shi (JP); Ryoichi HATANO, Kobe-shi (JP); Yoshitaka MURAMATSU, Kobe-shi (JP)

(73) Assignee: KAWASAKI JUKOGYO KABUSHIKI KAISHA, Kobe-shi, Hyogo (JP)

(21) Appl. No.: 19/475,712

(22) PCT Filed: Mar. 7, 2024
(86) PCT No.: PCT/JP2024/008800

§ 371 Date: Oct. 15, 2025

(30) Foreign Application Priority Data
May 24, 2023 (JP) 2023-085254

(51) Int. Cl. B23K 20/12

(52) U.S. Cl. CPC B23K 20/1255; B23K 20/1265

(57) ABSTRACT

A friction stir spot welding device includes a pin, a shoulder having therein a first hollow portion into which the pin is inserted, and a clamp having therein a second hollow portion into which the shoulder is inserted and having, in a peripheral wall, a first hole for allowing refrigerant to flow into the second hollow portion.

### TECHNICAL FIELD

The present disclosure relates to a friction stir spot welding device including a pin, a shoulder, and a clamp, and a friction stir spot welding method.

### BACKGROUND ART

As a method for overlapping and welding two or more members including a metal member, a fiber reinforced thermoplastic resin member, and the like, welding using friction stirring is known. For friction stir welding, a double-acting tool for friction stir spot welding including a pin and a shoulder having a hollow portion for accommodating the pin is sometimes used.

In the tool, since the pin or the shoulder is press-fitted into an object to be welded while being rotated at a high speed about an axis, the tool is heated to a high temperature by frictional heat or the like. When the tool is used at a high temperature, life of the tool tends to be shortened due to, for example, acceleration of wear and the easy reaction with a material of an object to be welded. For this reason, a tool for friction stir spot welding is desirably cooled at the time of use. Patent Literature 1 discloses a single-acting tool for friction stir spot welding including a pin that rotates around an axis, in which air is blown to the tool to cool the tool.

In a double-acting friction stir spot welding tool, a clamp surrounding an outer periphery of a shoulder is arranged. The clamp serves to prevent outflow of a friction stir material when a pin or shoulder performs friction stir. As described above, in a double-acting friction stir spot welding tool, a tool structure that covers a shoulder with a clamp is essential, and thus it is difficult to employ a tool cooling structure that simply blows air directly to the shoulder as in Patent Literature 1. Further, it is conceivable to indirectly cool a shoulder by blowing air to a clamp, but high cooling efficiency cannot be expected.

### CITATION LIST

### Patent Literature

Patent Literature 1: JP 2005-74451 A

### SUMMARY OF INVENTION

An object of the present disclosure is to provide a friction stir spot welding device and method capable of efficiently cooling a shoulder of a double-acting friction stir spot welding tool.

A friction stir spot welding device according to one aspect of the present disclosure includes a pin, a shoulder having therein a first hollow portion into which the pin is inserted, and a clamp having therein a second hollow portion into which the shoulder is inserted and having, in a peripheral wall, a first hole for allowing refrigerant to flow into the second hollow portion.

A friction stir spot welding method according to another aspect of the present disclosure is a friction stir spot welding method using a tool including a pin, a shoulder having therein a first hollow portion into which the pin is inserted, and a clamp having therein a second hollow portion into which the shoulder is inserted, the friction stir spot welding method including allowing refrigerant to flow into the second hollow portion from a refrigerant inflow hole provided in a peripheral wall of the clamp.

### Effect of the Invention

According to the present disclosure, it is possible to provide a friction stir spot welding device and method capable of efficiently cooling a shoulder of a double-acting friction stir spot welding tool.

### BRIEF DESCRIPTION OF DRAWINGS

FIG. 1 is a schematic diagram illustrating a configuration of a friction stir spot welding device according to an embodiment of the present disclosure.

FIG. 2 is a diagram illustrating an example of a welding method using the friction stir spot welding device.

FIG. 3A is a cross-sectional view of a friction stir spot welding tool according to a first embodiment included in the friction stir spot welding device.

FIG. 3B is a cross-sectional view of the friction stir spot welding tool according to a modification of the first embodiment.

FIG. 4A is a cross-sectional view of the friction stir spot welding tool according to a second embodiment.

FIG. 4B is a schematic cross-sectional view illustrating a discharge situation from a material discharge hole of a friction stir material in a tool of a comparative example.

FIG. 4C is a schematic cross-sectional view illustrating a discharge situation from a material discharge hole of a friction stir material in the tool of the second embodiment.

FIG. 5 is a cross-sectional view illustrating a clearance relationship in the tool of the second embodiment.

FIG. 6 is a cross-sectional view of the friction stir spot welding tool according to a third embodiment.

FIG. 7 is a cross-sectional view of the friction stir spot welding tool according to a fourth embodiment.

FIG. 8 is a cross-sectional view of the friction stir spot welding tool according to a fifth embodiment.

FIGS. 9A to 9D are cross-sectional views each illustrating a mode of blowing cooling air to a tool as a target of an experiment of measuring a side surface temperature of a shoulder.

FIG. 10 is a graph illustrating a result of the experiment of measuring a side surface temperature of the shoulder.

FIG. 11 is a cross-sectional view illustrating an embodiment in which a tool tip is blown.

FIG. 12 is a cross-sectional view illustrating another embodiment in which the tool tip is blown.

### DESCRIPTION OF EMBODIMENTS

Hereinafter, embodiments of the present disclosure will be described in detail with reference to the drawings. The friction stir spot welding device according to the present disclosure can be applied to manufacturing of various welded bodies obtained by overlapping two or more structural members such as a plate made from metal or resin, a frame, an exterior member, or a columnar member and performing spot welding. The welded body to be manufactured is a constituent member of a structure such as an aircraft, a railway vehicle, or an automobile.

### [Configuration of Friction Stir Spot Welding Device]

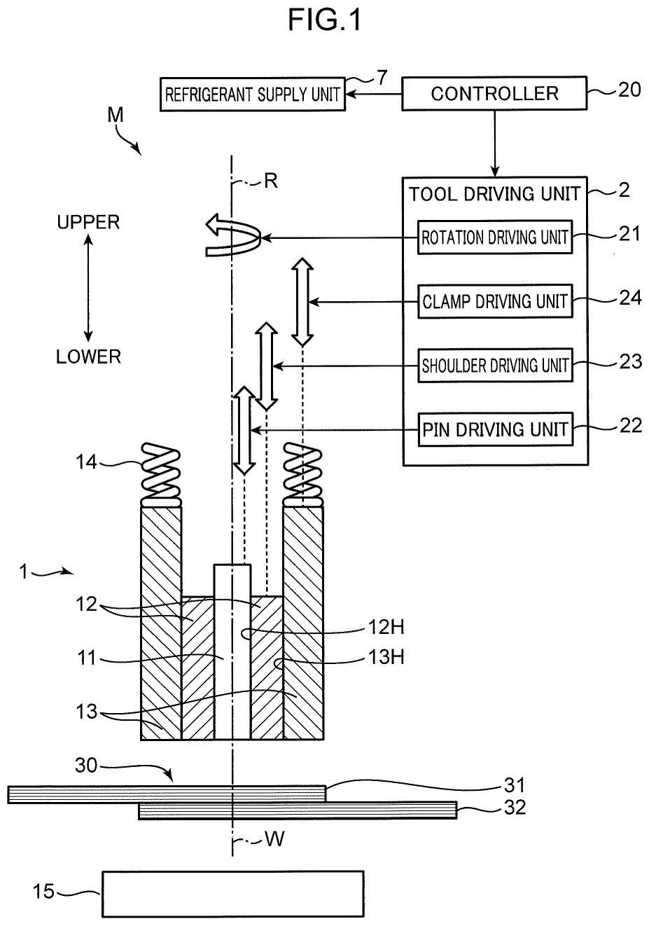

FIG. 1 is a schematic view illustrating a configuration of a friction stir spot welding device M according to an embodiment of the present disclosure. The friction stir spot welding device M includes a tool 1 for friction stir spot welding, a tool driving unit 2 that drives the tool 1 to rotate and move up and down, a refrigerant supply unit 7 that sends refrigerant to the tool 1, and a controller 20 that controls operation of each unit of the friction stir spot welding device M. Note that, in the drawings, there is a diagram indicating directions “up” and “down”, and this indication is for convenience of description, and is not intended to limit an actual use direction of the tool 1.

The tool 1 is supported by various tool fixing portions. For example, the tool fixing portion is a tip portion of an articulated robot. A backup 15 is arranged facing a lower end surface of the tool 1. At least two members to be welded are arranged between the tool 1 and the backup 15. FIG. 1 illustrates an example in which an overlapping portion 30 in which a part of a first member 31 including a flat plate and a part of a second member 32 similarly including a flat plate overlap each other in a vertical direction is arranged between the tool 1 and the backup 15.

The tool 1 includes a pin 11, a shoulder 12, a clamp 13, and a spring 14. The pin 11 is a member formed in a columnar shape, and is arranged such that its axis extends in the vertical direction. The pin 11 is rotatable about the axis as a rotation axis R, and is movable forward and backward in the vertical direction along the rotation axis R. Note that when the tool 1 is used, the rotation axis R and a spot welding position W in the overlapping portion 30 are aligned.

The shoulder 12 is a member formed in a cylindrical shape having a first hollow portion 12H into which the pin 11 is inserted. An axis of the shoulder 12 is coaxial with the axis of the pin 11, that is, the rotation axis R. The shoulder 12 can rotate about the rotation axis R and can move forward and backward in the vertical direction along the rotation axis R.

The tool 1 of the present embodiment is a double-acting tool in which the pin 11 and the shoulder 12 move independently in an axial direction. That is, both the shoulder 12 and the pin 11 inserted into the hollow portion can relatively move in the rotation axis R direction while rotating about the rotation axis R. Specifically, the pin 11 and the shoulder 12 can not only move up and down simultaneously along the rotation axis R, but also independently move so that one moves up and the other moves down.

The clamp 13 is a member formed in a cylindrical shape having a second hollow portion 13H into which the shoulder 12 is inserted. An axis of the clamp 13 is also coaxial with the rotation axis R. The clamp 13 does not rotate about the axis, but moves up and down, that is, moves forward and backward in the vertical direction along the rotation axis R. The clamp 13 surrounds the periphery of the shoulder 12 and serves to prevent outflow of a friction stir material when the pin 11 or shoulder 12 performs friction stir. That is, by surrounding of the clamp 13, a friction stir spot welding portion can be finished smoothly without scattering a friction stir material.

The spring 14 is attached to the upper end side of the clamp 13 and biases the clamp 13 downward toward the overlapping portion 30. The clamp 13 is attached to the tool fixing portion with the spring 14 interposed between them. The backup 15 includes a flat surface that abuts on the lower surface side of the overlapping portion 30 to be welded. The backup 15 is a backing member that supports the overlapping portion 30 when the pin 11 or the shoulder 12 is press-fitted into the overlapping portion 30. The clamp 13 biased by the spring 14 presses the overlapping portion 30 against the backup 15.

The tool driving unit 2 includes a rotation driving unit 21, a pin driving unit 22, a shoulder driving unit 23, and a clamp driving unit 24. The rotation driving unit 21 includes a motor, a driving gear, and the like, and rotatably drives the pin 11 and the shoulder 12 about the rotation axis R. The pin driving unit 22 is a mechanism that moves the pin 11 forward and backward along the rotation axis R. The pin driving unit 22 drives the pin 11 so that the pin 11 is press-fitted into the overlapping portion 30 and retracted from the overlapping portion 30. The shoulder driving unit 23 is a mechanism that moves the shoulder 12 forward and backward along the rotation axis R, and causes the shoulder 12 to be press-fitted into and retracted from the overlapping portion 30. The clamp driving unit 24 is a mechanism that moves the clamp 13 forward and backward along the rotation axis R. The clamp driving unit 24 moves the clamp 13 toward the overlapping portion 30 and presses the overlapping portion 30 against the backup 15. At this time, biasing force of the spring 14 acts.

The refrigerant supply unit 7 supplies refrigerant for cooling the shoulder 12 to the tool 1. As the refrigerant, gas such as air and nitrogen gas at room temperature, and liquid such as water and oil at room temperature can be used. As a specific example of the refrigerant supply unit 7, a device capable of generating high pressure air flow is provided, and for example, an axial flow fan including a multiblade fan or a turbo fan, a compressor, or the like can be exemplified. Supply of refrigerant from the refrigerant supply unit 7 may be performed either when the tool 1 is driven or when the tool 1 is not driven. When the tool 1 is driven, that is, when refrigerant is supplied while the tool 1 is operated, the shoulder 12 can be cooled in a timely manner.

The controller 20 includes a microcomputer or the like, and executes a predetermined control program to control operation of the tool driving unit 2 and the refrigerant supply unit 7. Specifically, the controller 20 controls the rotation driving unit 21 to perform required rotation operation of the pin 11 and the shoulder 12. Further, the controller 20 controls the pin driving unit 22, the shoulder driving unit 23, and the clamp driving unit 24 to perform required forward and backward movement operation of the pin 11, the shoulder 12, and the clamp 13. Furthermore, the controller 20 controls operation of the refrigerant supply unit 7 to control refrigerant supply operation to the tool 1.

### [Method of Using Tool]

Next, a method of using the tool 1 exemplified in the present embodiment will be described. As a method of using the friction stir spot welding device M, there are roughly a pin preceding process of first press-fitting the pin 11 of the tool 1 into an overlapping portion of a welding member and a shoulder preceding process of first press-fitting the shoulder 12 into an overlapping portion of a welding member. Here, the shoulder preceding process will be described. As a matter of course, the tool 1 may be used in the pin preceding process.

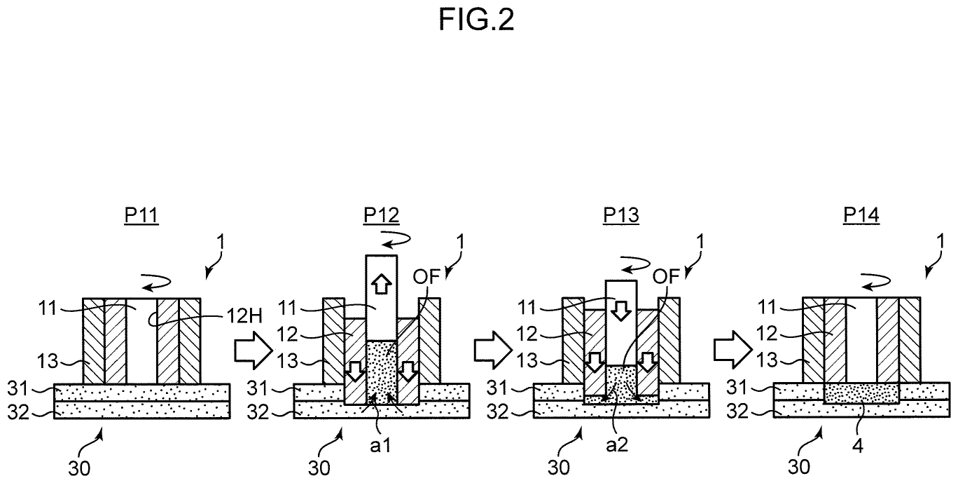

FIG. 2 is a diagram illustrating processes P11 to P14 of a friction stir spot welding method according to the shoulder preceding process. The processes P11 to P14 schematically illustrate a situation of friction stir spot welding of the overlapping portion 30 of the first member 31 and the second member 32. The process P11 illustrates a pre-heating step of the overlapping portion 30. The controller 20 rotates the pin 11 and the shoulder 12 around the axis at a predetermined rotation speed in a state where a lower end of the tool 1 abuts against a surface of the first member 31.

The process P12 illustrates a press-fitting step of the shoulder 12. In this press-fitting step, the controller 20 moves down the shoulder 12 to press-fit the shoulder 12 into the overlapping portion 30, and retracts the pin 11 upward. With this operation, a material of a press-fitting region of the shoulder 12 is stirred. Further, an overflow material OF overflowing from the overlapping portion 30 by the press fitting is released to the space of the first hollow portion 12H of the shoulder 12 generated by retraction of the pin 11 (see an arrow al). As described above, in the present embodiment, the pin 11 is relatively moved upward with respect to the shoulder 12 at the time of friction stir welding.

The process P13 illustrates a backfilling step of the overflow material OF. In the backfilling step, the controller 20 moves up and retracts the shoulder 12 and moves down the pin 11. As the pin 11 moves down, as indicated by an arrow a2, a press-fitting region of the shoulder 12 is backfilled with the overflow material OF released into the first hollow portion 12H. The process P14 illustrates a leveling step. In a state where lower end surfaces of the pin 11 and the shoulder 12 are returned to a height position of a surface of the first member 31, the controller 20 rotates both to smooth a spot welding portion. By the above process, a stirred and welded portion 4 is formed.

The shoulder 12 in the shoulder preceding process of FIG. 2 and the pin 11 in the pin preceding process (not illustrated) are press-fitted into the overlapping portion 30 while being rotated at high speed about an axis. For this reason, the tool 1 is heated to a high temperature by frictional heat or the like. As described above, when the tool 1 is used in a high temperature state, life of the tool 1 is shortened. Although it is conceivable to blow cooling air to the shoulder 12 at a high temperature to cool the shoulder 12, in the double-acting friction stir spot welding tool 1, an outer periphery of the shoulder 12 is surrounded by the clamp 13. In a case where cooling air is blown to the clamp 13 from the outside to indirectly cool the shoulder 12, high cooling efficiency cannot be expected. In view of the above circumstances, the present embodiment provides a tool structure in which the shoulder 12 of the double-acting friction stir spot welding tool 1 can be efficiently cooled. Hereinafter, a specific example of the tool structure will be described.

### First Embodiment of Tool

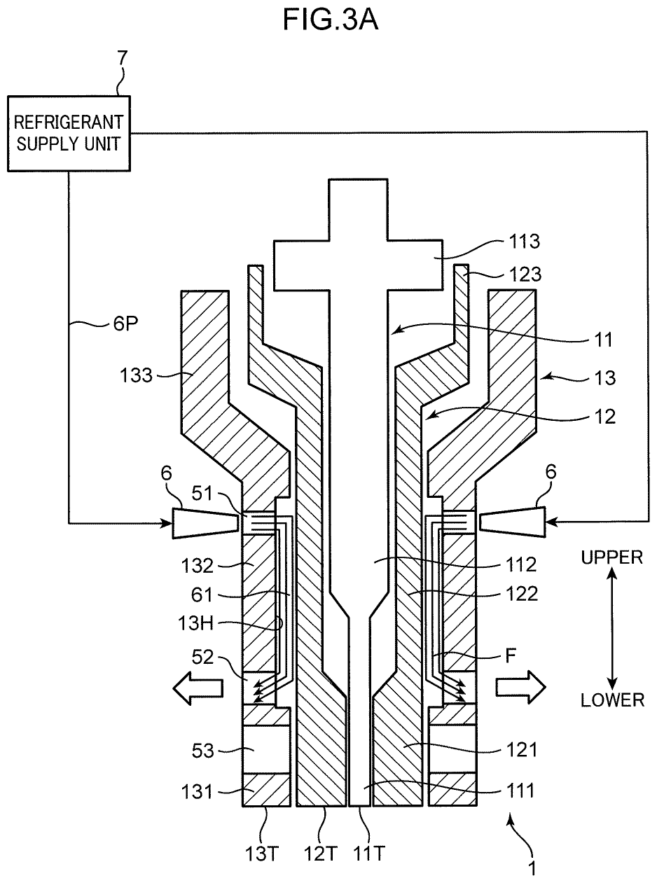

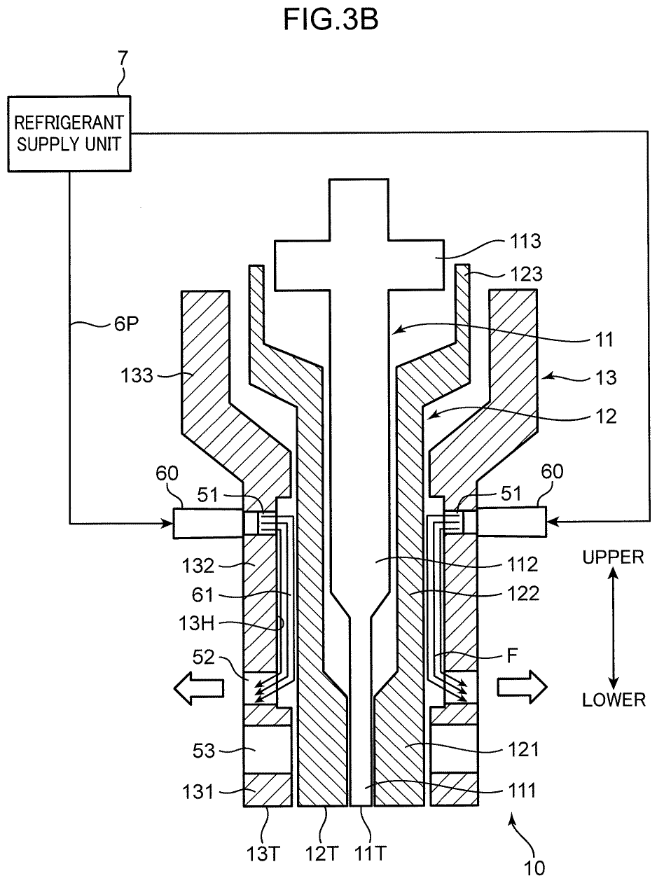

FIG. 3A is a cross-sectional view of the friction stir spot welding tool 1 according to the first embodiment. The tool 1 includes the pin 11, the shoulder 12 and the clamp 13. The pin 11 is formed of a cylindrical body whose diameter decreases stepwise in a downward direction, and includes a pin tip portion 111, a pin intermediate portion 112, and a pin base end portion 113. The pin tip portion 111 is a portion having a smallest outer diameter forming a tip portion in the pin 11, and a tip of the pin tip portion 111 is a lower end surface 11T of the pin 11. The pin intermediate portion 112 is a cylindrical portion having a larger diameter than the pin tip portion 111. The pin tip portion 111 and the pin intermediate portion 112 are connected by a tapered portion. The pin base end portion 113 is a portion which is located on the upper side of the pin intermediate portion 112 and to which driving force for rotating the pin 11 about an axis is applied.

The shoulder 12 is formed of a cylindrical body that accommodates the pin 11, and has a shoulder tip portion 121, a shoulder intermediate portion 122, and a shoulder base end portion 123. The shoulder 12 is made from a material having excellent heat resistance, such as cemented carbide. The shoulder tip portion 121 is a portion forming a tip portion in the shoulder 12, and a tip of the shoulder tip portion 121 is a lower end surface 12T of the shoulder 12. In the shoulder preceding process, the lower end surface 12T is a press-fitting tip into the overlapping portion 30. Therefore, the shoulder tip portion 121 is heated to a high temperature by frictional heat when the tool 1 is used. A tip hollow portion of a columnar type having an inner diameter slightly larger than an outer diameter of the pin tip portion 111 is formed inside the shoulder tip portion 121.

The shoulder intermediate portion 122 is a portion connected to the upper side of the shoulder tip portion 121, and includes a cylindrical intermediate hollow portion connected to the tip hollow portion inside the shoulder intermediate portion 122. An inner diameter of the intermediate hollow portion is slightly larger than an outer diameter of the pin intermediate portion 112. The shoulder base end portion 123 is a cylindrical portion connected to the upper side of the shoulder intermediate portion 122 with a tapered portion interposed between them. The shoulder base end portion 123 is a portion to which driving force for rotating the shoulder 12 about an axis is applied.

The clamp 13 is made from a cylindrical body that accommodates the shoulder 12, and includes a clamp tip portion 131, a clamp adapter 132, and a clamp base end portion 133. The clamp tip portion 131 is a portion forming a tip portion in the clamp 13, and a tip of the clamp tip portion 131 is a clamp lower end surface 13T. The clamp lower end surface 13T is pressed against the overlapping portion 30. The clamp tip portion 131 is a portion adjacent to the shoulder tip portion 121 heated to a higher temperature and is exposed to a high temperature. For this reason, the clamp tip portion 131 is made from a material having excellent heat resistance, such as cemented carbide, or alloy steel such as tool steel or high-speed steel.

The clamp adapter 132 is located above the clamp tip portion 131. The clamp adapter 132 can be made from metal, such as steel, for example. For example, a lower end inner peripheral surface of the clamp adapter 132 and an upper end outer peripheral surface of the clamp tip portion 131 are screwed together, so that the clamp tip portion 131 is attached to the clamp adapter 132. An annular space 61 having a relatively large gap width is set between an inner peripheral surface of the clamp adapter 132 and an outer peripheral surface of the shoulder intermediate portion 122. The annular space 61 is a part of the second hollow portion 13H described above. The clamp base end portion 133 is a portion connected to the upper side of the clamp adapter 132, and is a portion to which pressing force is applied from the spring 14.

Three holes extending in a radial direction, a first hole 51, a second hole 52, and a material discharge hole 53, are formed in a peripheral wall of the clamp 13. The first hole 51 is arranged in the vicinity of an upper end of the clamp adapter 132. The second hole 52 is arranged in the vicinity of a lower end of the clamp adapter 132. That is, the second hole 52 is arranged at a position different from the first hole 51 in an axial direction of the clamp 13, and the first hole 51 is arranged at a position higher than the second hole 52. The material discharge hole 53 is arranged in the clamp tip portion 131 below the second hole 52.

The first hole 51 is an opening for allowing refrigerant to flow into the second hollow portion 13H inside the clamp 13 and into the annular space 61 in a state where the shoulder 12 is accommodated in the clamp 13. FIG. 3 illustrates an example in which two of the first holes 51 are formed at positions facing each other in a circumferential direction. However, at least one opening for refrigerant inflow only needs to be opened, and the number and pitch of the first holes 51 may be appropriately set.

A nozzle 6 for supplying refrigerant is inserted into the first hole 51. The nozzle 6 may be permanently mounted in the first hole 51, or may be detachable from the first hole 51 by screwing, fitting, or the like. A supply pipe 6P extending from the refrigerant supply unit 7 is connected to the nozzle 6. A refrigerant such as air at room temperature fed from the refrigerant supply unit 7 can be supplied to the annular space 61 (second hollow portion 13H) through the supply pipe 6P and the nozzle 6. Note that the supply pipe 6P is desirably provided with a valve device that switches supply/stop of refrigerant. By using the nozzle 6 as a supply port for refrigerant instead of the first hole 51 itself provided in the clamp 13, the refrigerant can be easily supplied to the annular space 61.

The second hole 52 is an opening serving as a discharge path for refrigerant flowing into the annular space 61 from the first hole 51. Although FIG. 3 illustrates an example in which two of the second holes 52 are formed at positions facing each other in the circumferential direction, at least one of the second holes 52 only needs to be provided in a peripheral wall of the clamp 13. By forming the second hole 52, refrigerant flow F from the first hole 51 toward the second hole 52 can be formed in the annular space 61.

The material discharge hole 53 is an opening for releasing a friction stir material inevitably entering a gap between the shoulder tip portion 121 and the clamp tip portion 131 to the outside. While the clamp 13 is immovable, the shoulder 12 rotates about the rotation axis R and moves up and down along the rotation axis R. For this reason, clearance is required between the shoulder 12 and the clamp 13. As described in process P12 of FIG. 2, when the shoulder 12 is press-fitted, the pin 11 retracts upward, and a space for releasing a friction stir material is created. However, not all of the friction stir material is directed into the space, and some enters the clearance between the shoulder 12 and the clamp 13. The same applies to the backfilling step of the process P13. The interposition of the friction stir material in the clearance increases sliding resistance of the shoulder 12 and affects operation of the tool 1.

The friction stir material that enters the clearance gradually rises to the upper side of the tool 1. The material discharge hole 53 functions as an opening for discharging such a friction stir material to the outside. By discharging a friction stir material from the material discharge hole 53, increase in sliding resistance of the shoulder 12 described above is suppressed.

Operation and an advantage of the tool 1 according to the first embodiment will be described. In a case where the tool 1 is used in the shoulder preceding process illustrated in FIG. 2, the shoulder 12 is press-fitted into the overlapping portion 30 while being rotated about an axis. At the same time, refrigerant is supplied from the refrigerant supply unit 7 to the nozzle 6 attached to the first hole 51 through the supply pipe 6P. A refrigerant flows from the nozzle 6 into the annular space 61 and forms the refrigerant flow F toward the second hole 52 in the annular space 61. After the above, the refrigerant is discharged from the second hole 52 to the outside.

By the press-fitting, the shoulder 12 is subjected to frictional heat. However, since refrigerant flows into the annular space 61 from the first hole 51, direct heat exchange occurs between the refrigerant and the shoulder 12, and the shoulder 12 is cooled. Therefore, it is possible to efficiently cool the shoulder 12 as compared with a case where the shoulder 12 is indirectly cooled by blowing cooling air to an outer periphery of the clamp 13. Moreover, since the refrigerant flow F flowing from the first hole 51 toward the second hole 52 flows along an outer peripheral surface of the shoulder 12, heat exchange between the refrigerant and the shoulder 12 is promoted, and the shoulder 12 can be efficiently cooled. Here, the first hole 51 serving as an inlet for refrigerant is arranged on a peripheral wall of the clamp 13. In an aspect in which refrigerant is supplied from a gap between the shoulder 12 and the clamp 13 in an upper portion of the tool 1, the refrigerant is heated in the gap before reaching a region of the annular space 61 where cooling is required, and cooling efficiency decreases. Since the present embodiment is an aspect in which refrigerant is supplied from a peripheral wall of the clamp 13, cooling efficiency is high.

Further, since the second hole 52 for refrigerant discharge is provided separately from the material discharge hole 53, the refrigerant flow F from the first hole 51 toward the second hole 52 can be stably formed. Furthermore, since a position of the second hole 52 can be freely set, there is also an advantage that it is easy to perform a cooling design according to actual heat generation behavior of the shoulder 12 or a design in consideration of strength of the clamp 13. Note that when a distance between the first hole 51 and the second hole 52 is too short, a cooling width of the shoulder 12 is shortened and strength of the clamp 13 is reduced. Positions of the first hole 51 and the second hole 52 are desirably set in consideration of factors such as cooling efficiency and strength.

FIG. 3B is a cross-sectional view of a friction stir spot welding tool 10 according to a modification of the first embodiment. The friction stir spot welding tool 10 is different from the above-described friction stir spot welding tool 1 in that a member attached to the first hole 51 for supplying refrigerant is an adapter 60, and the other configurations are the same. The adapter 60 is a member that has a supply hole for allowing refrigerant to pass through and is tightly attached to the first hole 51.

As the adapter 60, for example, a one touch pipe fitting having a screw thread at an end portion on a side attached to the first hole 51 can be used. A fitting type may be a linear type, an elbow type, or the like. In this case, a thread groove is formed on an inner surface of the first hole 51, and an end portion having a screw thread of the adapter 60 is screwed into the first hole 51. The supply pipe 6P is connected to another end portion of the adapter 60. In the friction stir spot welding tool 10 of the modification, refrigerant can flow from the supply pipe 6P into the annular space 61 through the adapter 60 tightly attached to the first hole 51. For this reason, leakage of refrigerant from the first hole 51 is suppressed, and as a result, an amount of refrigerant supplied to the annular space 61 can be increased. Therefore, cooling efficiency of the shoulder 12 by refrigerant can be improved.

### Second Embodiment of Tool

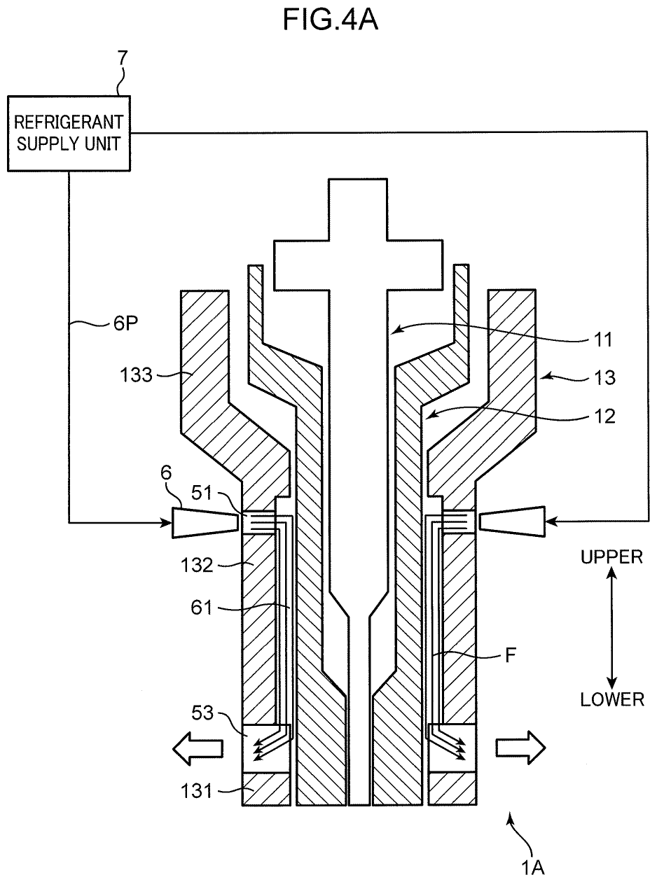

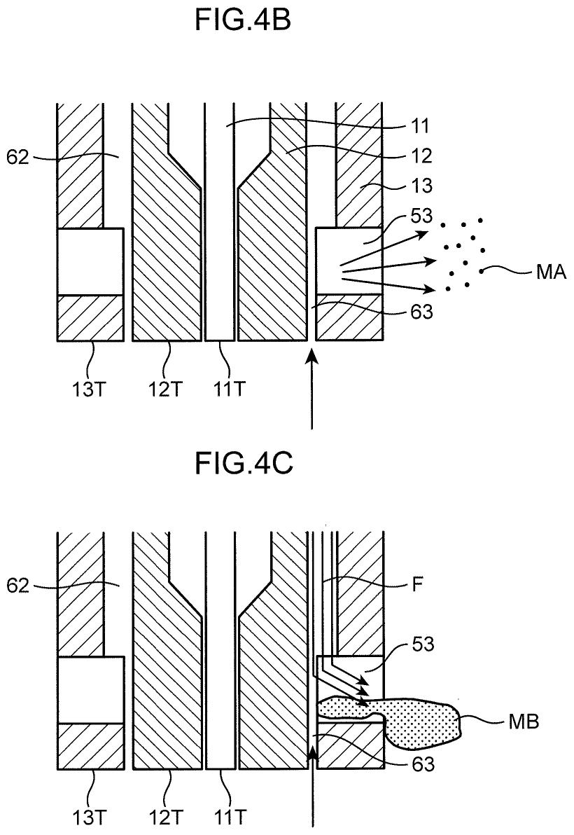

FIG. 4A is a cross-sectional view of a friction stir spot welding tool 1A according to a second embodiment. A basic configuration of the tool 1A is similar to that of the tool 1 of the first embodiment, and includes the pin 11, the shoulder 12, and the clamp 13. A difference from the first embodiment is that the material discharge hole 53 for releasing a friction stir material entering between the shoulder 12 and the clamp 13 to the outside is used as an opening for discharging refrigerant. That is, in the tool 1A, the material discharge hole 53 also serves as the second hole 52 of the tool 1 of the first embodiment. Therefore, the second hole 52 is not formed in the clamp 13 of the tool 1A.

Refrigerant supplied from the refrigerant supply unit 7 flows into the annular space 61 through the nozzle 6 and the first hole 51. The refrigerant flow F generated by refrigerant that flows in exchanges heat with an outer peripheral surface of the shoulder 12 to cool the shoulder 12. This operation is the same as that of the first embodiment. On the other hand, a discharge path of the refrigerant flow F is the material discharge hole 53. Refrigerant flowing into the annular space 61 is discharged from the material discharge hole 53 to the outside. The material discharge hole 53 is normally not completely closed by a friction stir material, and thus can be used as a discharge hole for refrigerant.

According to the tool 1A of the second embodiment, since the material discharge hole 53 is used as a discharge hole for refrigerant, it is not necessary to newly drill a discharge hole for refrigerant in the clamp 13. Further, when a friction stir material that enters clearance between the shoulder 12 and the clamp 13 is discharged from the material discharge hole 53, the friction stir material and refrigerant come into contact with each other. For this reason, there is also an advantage that a friction stir material can be cooled to form an agglomerate and then discharged from the material discharge hole 53. This advantage will be described with reference to FIGS. 4B and 4C.

FIG. 4B is a schematic cross-sectional view illustrating a discharge situation from the material discharge hole 53 of a friction stir material in a tool of a comparative example not having an inflow path of refrigerant, that is, the first hole 51. In the tool of the comparative example, the friction stir material that enters the clearance moves to the material discharge hole 53 while being at a high temperature, and is discharged to the outside from the material discharge hole 53 in a state of a fine piece MA. In this case, there may be a problem that a scattered material of the fine piece MA adheres to a surface of an object to be welded to cause coating unevenness, or the fine piece MA floats and deteriorates a work environment.

FIG. 4C is a schematic cross-sectional view illustrating a discharge situation from the material discharge hole 53 of a friction stir material in the tool 1A of the second embodiment. In the tool 1A, the refrigerant flow F that flows through the annular space 61 and is discharged from the material discharge hole 53 after cooling the shoulder 12 is generated. Similarly, a friction stir material discharged from the material discharge hole 53 is cooled by contact with the refrigerant flow F. Further, since the shoulder 12 is also cooled by the refrigerant flow F, a friction stir material is also cooled when the friction stir material moves up clearance between the shoulder 12 and the clamp 13. By these cooling actions, a friction stir material discharged from the material discharge hole 53 becomes not the fine pieces MA separated from each other but agglomerates MB which are in a form of a continuous mass. Therefore, in the tool 1A, a friction stir material does not scatter as in the comparative example. Further, since the agglomerate MB can be easily removed with a spatula or the like, post-treatment is also easy.

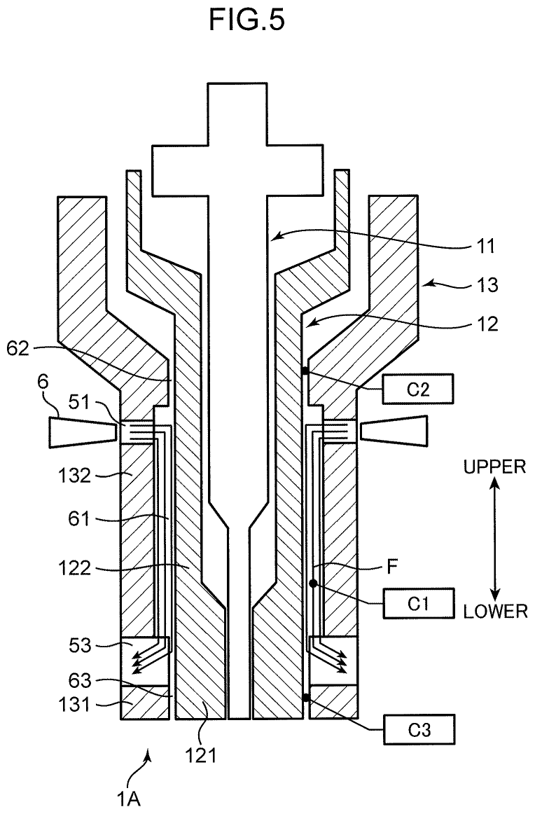

The tool 1A of the second embodiment also focuses on clearance between an inner peripheral wall of the clamp 13 and an outer peripheral wall of the shoulder 12. This point will be described with reference to FIG. 5.

A space between the clamp 13 and the shoulder 12 between the first hole 51 and the material discharge hole 53 as the second hole, specifically, a space between an inner peripheral wall of the clamp adapter 132 and an outer peripheral wall of the shoulder intermediate portion 122 is the annular space 61 through which the refrigerant flow F is intended to flow. Clearance, in other words, width in a radial direction of the annular space 61 is denoted by C1. An upper annular space 62 is formed between the clamp 13 and the shoulder 12 on the side farther from the clamp lower end surface 13T than the first hole 51, that is, on the upper side of the first hole 51. Further, a lower annular space 63 is formed between the clamp tip portion 131 and the shoulder tip portion 121 closer to the clamp lower end surface 13T than the material discharge hole 53, that is, on the lower side of the second hole 52. Clearance of the upper annular space 62 is denoted by C2, and clearance of the lower annular space 63 is denoted by C3. At this time, a relationship between the clearances C1, C2, and C3 is set to satisfy a relationship of Formula (1) below.

$$C 1 > C 2 , C 1 > C 3 \qquad ( 1 )$$

When Formula (1) above is satisfied, the annular space 61 between the material discharge hole 53 and the first hole 51 serving as a path of the refrigerant flow F has a wide clearance, and the upper annular space 62 and the lower annular space 63 sandwiching the annular space 61 from above and below have clearance of narrow width. When C1>C2, refrigerant supplied from the first hole 51 is less likely to flow upward through the upper annular space 62, and the refrigerant flow F is easily formed in the annular space 61. When C1>C3, refrigerant can be made difficult to flow out to a tip surface side of the tool 1 through the lower annular space 63, and the refrigerant flow F flowing out exclusively from the material discharge hole 53 can be easily formed.

According to the tool 1A of the second embodiment, refrigerant is likely to preferentially flow between the first hole 51 and the material discharge hole 53 as the second hole by setting a relationship between the clearances C1, C2, and C3 in Formula (1) above. Therefore, in the annular space 61, heat exchange between the refrigerant flow F and the shoulder 12 can be efficiently performed.

### Third Embodiment of Tool

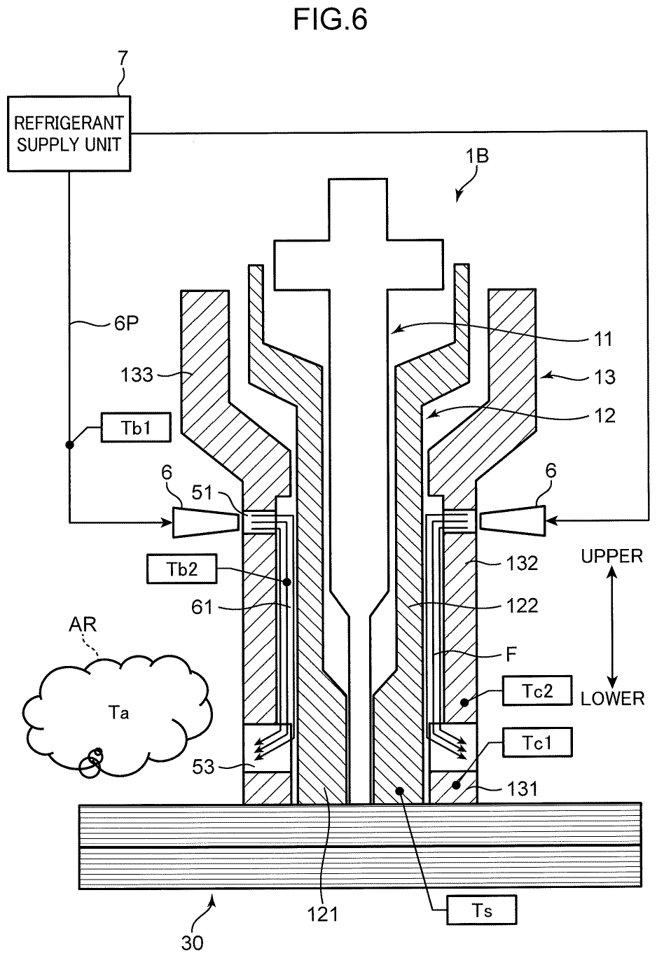

FIG. 6 is a cross-sectional view of a friction stir spot welding tool 1B according to a third embodiment. A configuration of the tool 1B is similar to that of the tool 1A of the second embodiment, and includes the pin 11, the shoulder 12, and the clamp 13 having the first hole 51 for refrigerant inflow and the material discharge hole 53 also serving as a refrigerant discharge hole. The tool 1B of the third embodiment focuses on thermal conductivity of a material constituting the shoulder 12 and the clamp 13.

The clamp 13 of the tool 1B has a region where thermal conductivity is lower than thermal conductivity of the shoulder 12 on a peripheral wall defining the annular space 61 which is a path of refrigerant between the first hole 51 and the material discharge hole 53 (second hole). In the present embodiment, a peripheral wall that defines the annular space 61 is the clamp adapter 132, and the first hole 51 and the material discharge hole 53 are also provided in the clamp adapter 132. Therefore, a material lower in thermal conductivity than a constituent material of the shoulder 12 is selected as a constituent material of the clamp adapter 132. For example, if a constituent material of the shoulder 12 is cemented carbide which is a sintered body of a mixture of tungsten carbide and cobalt, and a constituent material of the clamp adapter 132 is steel or ceramic, the above relationship of thermal conductivity is satisfied.

On the other hand, since the clamp tip portion 131 attached to a lower end of the clamp adapter 132 is a region facing the shoulder tip portion 121 that performs friction stir, the clamp tip portion 131 receives the same heat as the shoulder tip portion 121. Since the clamp lower end surface 13T, which is an end surface of the clamp tip portion 131, is pressed against the overlapping portion 30, corresponding strength is required. Therefore, a constituent material of the clamp tip portion 131 is also desirably the same cemented carbide as the shoulder 12. In a case where the clamp tip portion 131 is made from cemented carbide and the clamp adapter 132 is made from steel, the clamp adapter 132 is made from a material having lower thermal conductivity than the clamp tip portion 131.

A temperature relationship during use of the tool 1B made from the above constituent materials is as described below. When an ambient temperature of the overlapping portion 30 into which the tool 1B is press-fitted is denoted by Ta, a temperature of the shoulder tip portion 121 is denoted by Ts, a temperature of the clamp tip portion 131 is denoted by Tc1, a temperature of the clamp adapter 132 is denoted by Tc2, a temperature of refrigerant supplied from the refrigerant supply unit 7 is denoted by Tb1, and a temperature of the refrigerant flow F flowing through the annular space 61 is denoted by Tb2, a temperature relationship is as shown in Formula (2) below.

The following relationship is established:

$$Ts > Tc 1 > Tc 2 > T a > Tb 2 \approx Tb 1. \qquad ( 2 )$$

According to the tool 1B of the third embodiment, air heat around the friction stir spot welding device M and heat of another portion of the clamp 13 can be made difficult to be transferred to the refrigerant flow F flowing through the annular space 61. That is, since the clamp adapter 132 is made from a material having low thermal conductivity, a peripheral wall between the first hole 51 and the material discharge hole 53 provides a heat insulating action, and heat transfer to the refrigerant flow F is suppressed. Further, even if the clamp tip portion 131 becomes highly heated, the heat is less likely to be transferred to the clamp adapter 132, and as a result, the refrigerant flow F is less likely to be heated by friction stir heat. For this reason, the relationship of Tb2≈Tb1 of Formula (2) described above can be maintained. That is, most of cooling energy of refrigerant supplied from the refrigerant supply unit 7 can be consumed for heat exchange with the shoulder 12, and the shoulder 12 can be efficiently cooled.

In the tool 1B, the example in which the clamp adapter 132 is made from a material having low thermal conductivity is described, but at least a part of the peripheral wall between the first hole 51 and the material discharge hole 53 (second hole) may be made from a material having thermal conductivity lower than thermal conductivity of the shoulder 12, that is, a material exhibiting heat insulating property. For example, an aspect in which a ring-shaped member having heat insulating property is attached to a lower end of a clamp adapter that is used conventionally, and a clamp tip portion is attached to a lower end of the ring-shaped member may be employed. In this case, openings corresponding to the first hole and the second hole through which the refrigerant flows may be formed at positions sandwiching the ring-shaped member or on the ring-shaped member.

### Fourth Embodiment of Tool

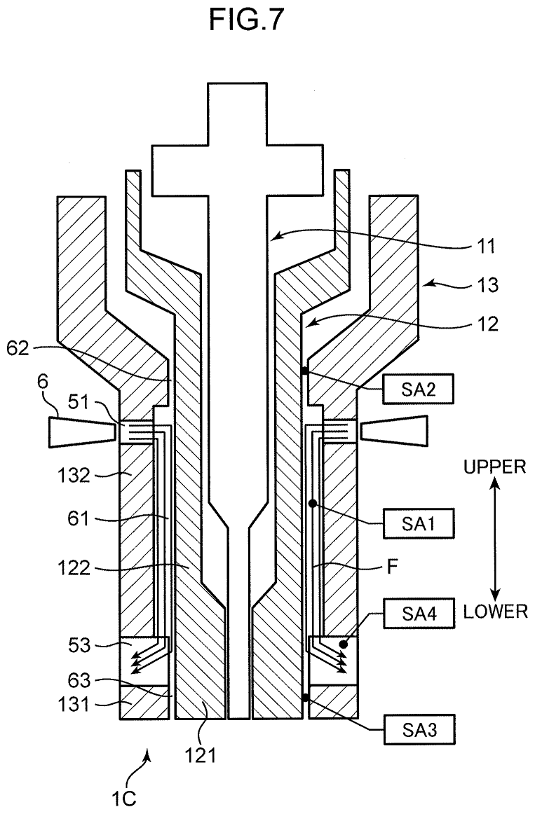

FIG. 7 is a cross-sectional view of a friction stir spot welding tool 1C according to a fourth embodiment. A configuration of the tool 1C is similar to that of the tool 1A of the second embodiment, and includes the pin 11, the shoulder 12, and the clamp 13 having the first hole 51 for refrigerant inflow and the material discharge hole 53 also serving as a refrigerant discharge hole. The tool 1C of the fourth embodiment focuses on a cross-sectional area of a space between the clamp 13 and the shoulder 12.

Regarding a cross-sectional area of a space between an inner peripheral wall of the clamp 13 and an outer peripheral wall of the shoulder 12 in a direction orthogonal to a central axis (the rotation axis R in FIG. 1) of the clamp 13, a cross-sectional area between the first hole 51 and the material discharge hole 53 as the second hole is denoted by SAL. That is, a cross-sectional area obtained by slicing the annular space 61 through which refrigerant flow F is intended to flow is denoted by SA1. A cross-sectional area of the upper annular space 62 above the first hole 51 is denoted by SA2, and a cross-sectional area of the lower annular space 63 below the material discharge hole 53 is denoted by SA3. Furthermore, an opening area of the material discharge hole 53 as the second hole which is an outlet of the refrigerant flow F is denoted by SA4. At this time, a relationship between the cross-sectional areas SA1, SA2, and SA3 and the opening area SA4 is set to satisfy a relationship of Formula (3) below.

$$S A 1 > S A 2 , S A 1 > S A 3 , S A 4 > S A 2 , S A 4 > SA 3 \qquad ( 3 )$$

When Formula (3) above is satisfied, the annular space 61 between the material discharge hole 53 and the first hole 51 serving as a path of the refrigerant flow F and the material discharge hole 53 serving as an outlet of the refrigerant flow F have a relatively large cross-sectional area. On the other hand, the upper annular space 62 and the lower annular space 63 vertically sandwiching the annular space 61 and the material discharge hole 53 have a relatively small cross-sectional area. When SA1>SA2 and SA4>SA2, refrigerant supplied from the first hole 51 can be made difficult to flow upward through the upper annular space 62, and the refrigerant flow F is easily formed in the annular space 61. When SA1>SA3 and SA4>SA3, refrigerant can be made difficult to flow out to a tip surface side of the tool 1 through the lower annular space 63, and the refrigerant flow F flowing out exclusively from the material discharge hole 53 can be easily formed.

According to the tool 1C of the fourth embodiment, by setting the relationship between the cross-sectional areas SA1, SA2, and SA3 and the opening area SA4 in Formula (3) above, similarly to the second embodiment, refrigerant is likely to preferentially flow between the first hole 51 and the material discharge hole 53 as the second hole. Therefore, in the annular space 61, heat exchange between the refrigerant flow F and the shoulder 12 can be efficiently performed.

### Fifth Embodiment

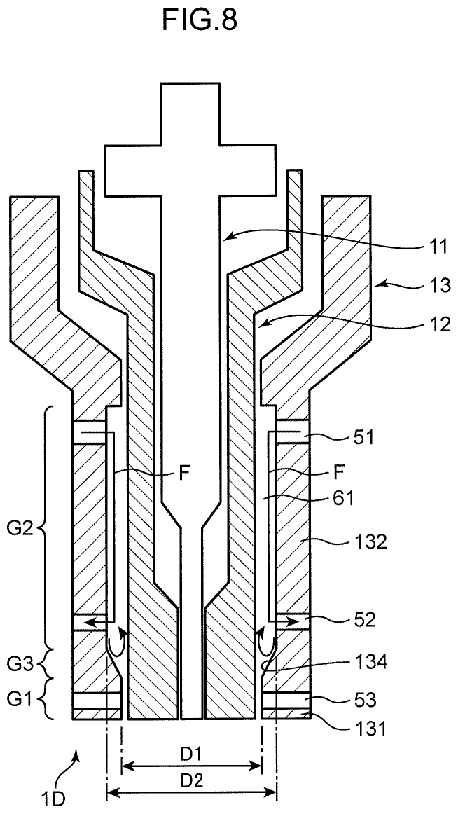

FIG. 8 is a cross-sectional view of a friction stir spot welding tool 1D according to a fifth embodiment. The tool 1D includes the pin 11, the shoulder 12, and the clamp 13 having the first hole 51 for refrigerant inflow, the second hole 52 for refrigerant discharge, and the material discharge hole 53. The clamp 13 of the fifth embodiment includes a tapered surface 134 between an inner surface of the clamp tip portion 131 and an inner surface of the clamp adapter 132. The tapered surface 134 is an inner surface whose inner diameter gradually decreases toward a tool tip.

As described above, the material discharge hole 53 is an opening for discharging a friction stir material that enters clearance between the shoulder 12 and the clamp 13 to the outside. At the time of the discharge, a friction stir material desirably passes through the material discharge hole 53 in a state of an agglomerate having fluidity. That is, a friction stir material that enters clearance is desirably discharged from the material discharge hole 53 without being solidified. In order to suppress the solidification, a friction stir material is desirably not excessively cooled by refrigerant flowing through the annular space 61. The fifth embodiment takes this point into consideration.

A peripheral wall of the clamp 13 of the fifth embodiment includes a first region G1, a second region G2, and an intermediate region G3. The first region E1 corresponds to the clamp tip portion 131 constituting a tip of the clamp 13. An inner diameter of the first region G1 is a predetermined first length D1. The first length D1 is slightly greater than an outer diameter of the shoulder 12. The second region G2 is located above the first region E1 and substantially corresponds to the clamp adapter 132. An inner diameter of the second region G2 is a second length D2 longer than the first length D1. The second length D2 is set to a length that can define the annular space 61 through which a sufficient amount of refrigerant can flow between the clamp 13 and the shoulder 12. The intermediate region G3 is located between the first region G1 and the second region G2. An inner surface of the intermediate region G3 is the tapered surface 134 that compensates for a diameter difference between the first length D1 and the second length D2. The first hole 51 and the second hole 52 are arranged in the second region G2. The material discharge hole 53 is arranged in the first region G1.

Between the second hole 52, which is a discharge hole for the refrigerant flow F, and the material discharge hole 53, there is the tapered surface 134 that gradually narrows a space between an outer peripheral surface of the shoulder 12 and an inner peripheral surface of the clamp 13. For this reason, the refrigerant flow F is less likely to flow toward the material discharge hole 53, and is discharged exclusively from the second hole 52. The refrigerant flow F that once passes through the second hole 52 is also easily guided by the tapered surface 134 to become reverse flow toward the second hole 52. Therefore, a friction stir material present in the vicinity of an inlet of the material discharge hole 53 is less likely to be excessively cooled by the refrigerant flow F, and solidification is suppressed. By this, a friction stir material can be discharged from the material discharge hole 53 in a state of a mass having fluidity.

### [Confirmation Test for Shoulder Cooling Effect]

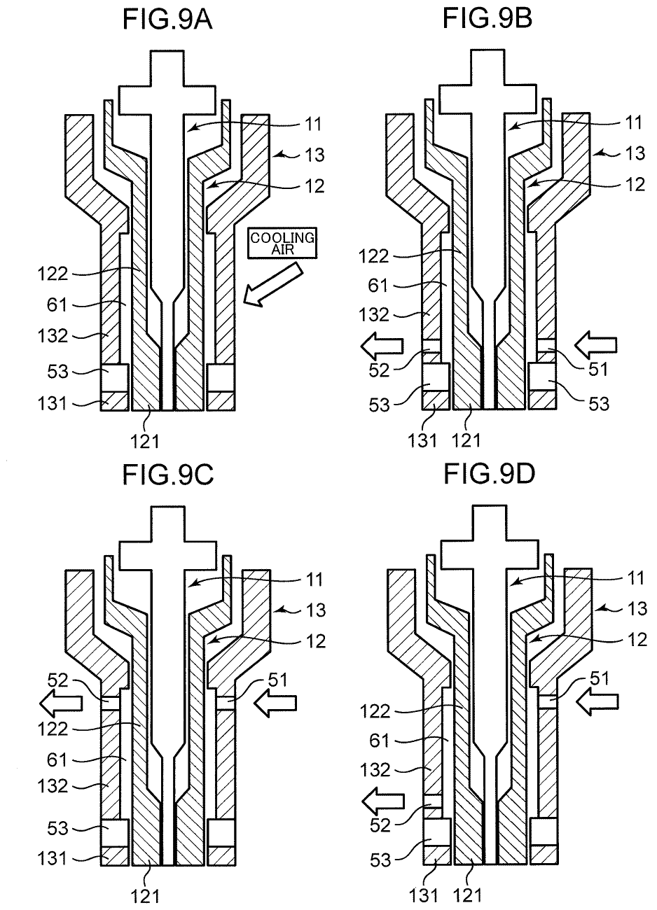

Next, a result of a confirmation test for a cooling effect of the shoulder 12 by blowing of cooling air is shown. The confirmation test was performed by numerical analysis. In order to confirm the cooling effect, a side surface temperature of the shoulder 12 when the tool 1 was press-fitted into a test piece without blowing cooling air and a side surface temperature of the shoulder 12 when four types of the tools 1 having different blowing modes of cooling air were press-fitted into a test piece were measured. FIGS. 9A to 9D are cross-sectional views each illustrating a mode of blowing cooling air to the tool 1.

FIG. 9A illustrates an air blowing mode of a comparative example. In this example, the clamp 13 is not provided with the first hole 51 into which refrigerant flows, and cooling air is blown against an outer peripheral surface of the clamp 13 to indirectly cool the shoulder 12. FIGS. 9B to 9D are air blowing modes corresponding to the embodiment of the present disclosure, and illustrate an example in which the shoulder 12 is directly cooled with cooling air. FIG. 9B illustrates an example in which the first hole 51 for inflow of cooling air and the second hole 52 for discharge of cooling air are arranged to face each other at positions immediately above two of the material discharge holes 53. FIG. 9C illustrates an example in which the first hole 51 and the second hole 52 are arranged so as to face each other at upper positions of the clamp 13. FIG. 9D illustrates an example in which cooling air flows in from a single first hole 51 located above the clamp 13 and is discharged from a single second hole 52 located below the clamp 13.

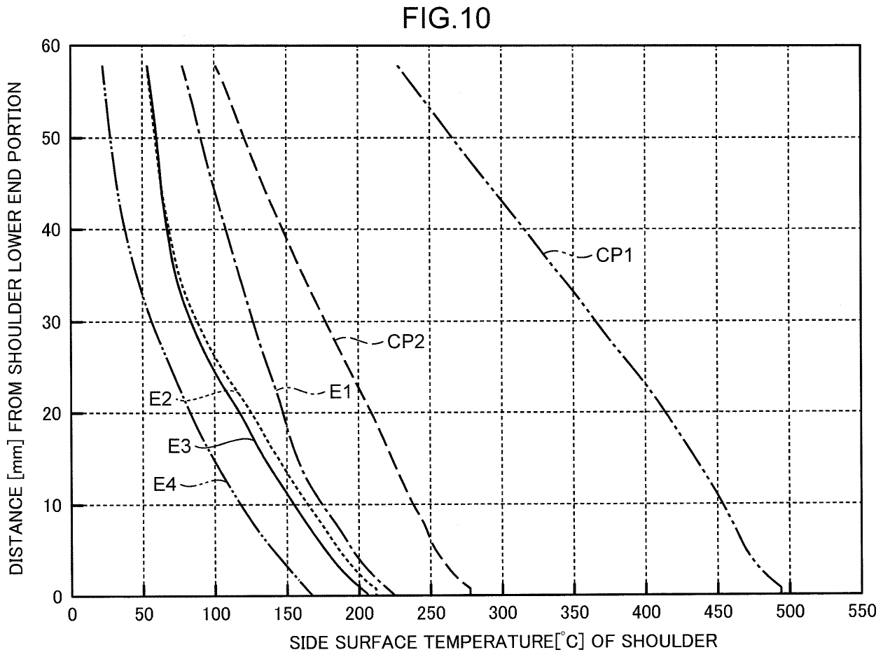

FIG. 10 is a graph illustrating an analysis result of the side surface temperature of the shoulder 12. The vertical axis of the graph indicates distance in a height direction from the shoulder lower end surface 12T (FIG. 3A). A position at the distance=0 mm is the shoulder lower end surface 12T. A graph CP1 of FIG. 9 indicates a side surface temperature of the shoulder 12 in a case where cooling air is not blown against the tool 1. A side surface temperature in the vicinity of the shoulder tip portion 121 increases to the vicinity of 500° C. When the tool 1 is used in a state where the shoulder 12 is heated in this manner, life of the tool 1 tends to be short. A graph CP2 illustrates a side surface temperature in a case where the shoulder 12 is indirectly cooled illustrated in FIG. 9A. Although the side surface temperature of the shoulder 12 is lower than that in the graph CP1 in which cooling is not performed, the temperature is higher than 250° C. in the vicinity of the shoulder tip portion 121.

A graph E1 illustrates a side surface temperature of the shoulder 12 in a case where cooling air illustrated in FIG. 9B is directly blown. As compared with the graph CP2 of the comparative example, the graph E1 shows that a cooling effect is improved by about 50° C. or more in the vicinity of the shoulder tip portion 121. A graph E2 and a graph E3 illustrate a side surface temperature of the shoulder 12 in a case where direct blowing of cooling air shown in FIG. 9C and FIG. 9D is performed, respectively. The graphs E1 to E3 are graphs calculated assuming use of the friction stir spot welding tool 1 having the nozzle 6 illustrated in FIG. 3A. On the other hand, a graph E4 is a graph calculated using the friction stir spot welding tool 10 having the adapter 60 illustrated in FIG. 3B and assuming direct blowing of cooling air illustrated in FIG. 9D.

In the graphs E2 and E3, a cooling effect is more improved than in the graph E1. In particular, it has been confirmed that the mode of FIG. 8D, that is, the graph E3 in a case where cooling air flows into the annular space 61 from the first hole 51 in an upper portion of the clamp 13 and is discharged from the second hole located in a lower portion of the clamp 13 is excellent in a cooling effect of the shoulder 12. Furthermore, in the mode of FIG. 8D, it was confirmed that the graph E4 in the case of using the adapter 60 that can be closely attached to the first hole 51 exhibits a most excellent cooling effect of the shoulder 12.

### [Embodiment of Blowing Tool Tip]

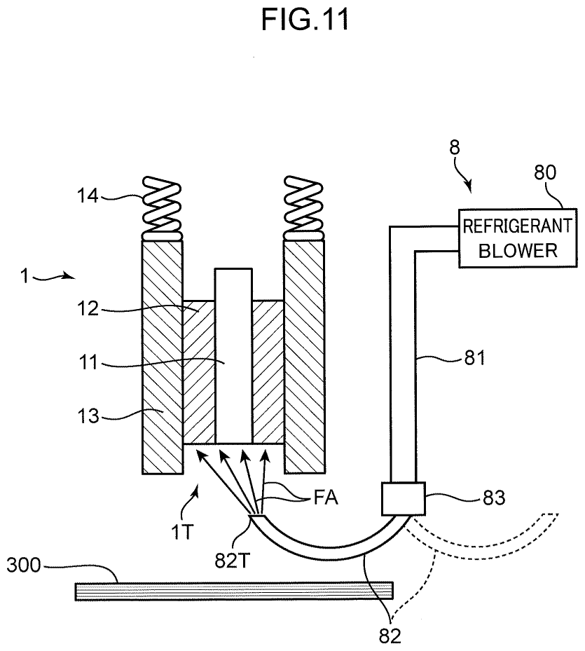

FIG. 11 is a cross-sectional view illustrating an embodiment in which a tool tip 1T is blown. The tool tip 1T of the tool 1 is a portion that is in direct contact with a workpiece 300. For this reason, when the tool 1 is driven, the tool tip 1T is heated to a high temperature. Heating to an excessively high temperature may accelerate damage and deterioration of the tool tip 1T. Further, a foreign matter easily adheres to the tool tip 1T. The foreign matter is, for example, material waste of the workpiece 300, oil or material waste leaking from between tool elements, i.e., between the pin 11 and the shoulder 12 or between the shoulder 12 and the clamp 13. When a foreign matter on the tool tip 1T is mixed into a friction stir spot welding portion, strength of the welding portion may be reduced. In order to solve these problems, FIG. 11 illustrates an embodiment provided with equipment for blowing the tool tip 1T.

The tool 1 of FIG. 11 is provided with a tool tip blow unit 8 that blows refrigerant flow FA to the tool tip 1T. The tool tip blow unit 8 includes a refrigerant blower 80, an air supply pipe 81, a nozzle 82, and a swivel joint 83. The refrigerant blower 80 is a supply source of the refrigerant flow FA to be blown. The refrigerant blower 80 includes a compressor or a blower that pressurizes and feeds refrigerant. The refrigerant may be air. The air supply pipe 81 feeds refrigerant to the nozzle 82. The nozzle 82 has a tip opening 82T through which the refrigerant flow FA is blown out. The nozzle 82 has a U-shape, and the tip opening 82T can face the tool tip 1T from below. The swivel joint 83 rotatably connects the nozzle 82 to the air supply pipe 81.

The tool tip 1T is cooled by blowing the refrigerant flow FA from the tip opening 82T of the nozzle 82. For this reason, excessive temperature increase of the tool tip 1T is suppressed. Further, when the refrigerant flow FA is blown, a foreign matter attached to the tool tip 1T is blown off. Since the refrigerant flow FA is blown between the pin 11 and the shoulder 12 and also between the shoulder 12 and the clamp 13, the refrigerant flow FA also contributes to cleaning between these tool elements. Note that, at a timing when the tool 1 attacks the workpiece 300, the nozzle 82 rotates around the swivel joint 83 and retracts from below the tool tip 1T. Instead of the configuration in which the nozzle 82 is retracted by the swivel joint 83, for example, a configuration in which the entire tool tip blow unit 8 is moved or a configuration in which the nozzle 82 is moved forward and backward by moving the air supply pipe 81 may be employed.

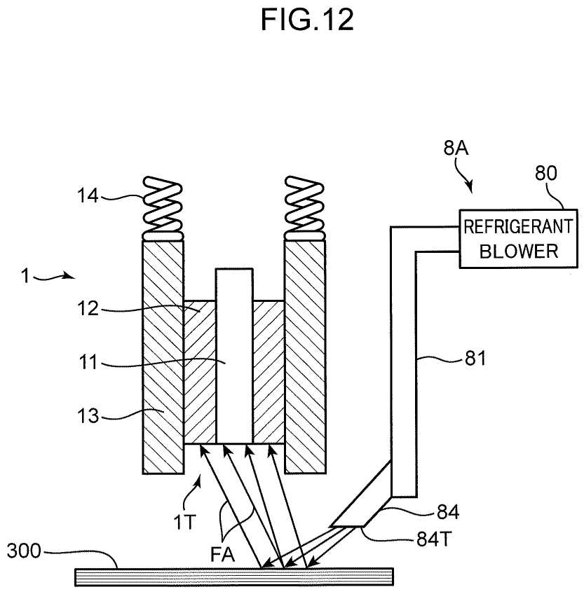

FIG. 12 is a cross-sectional view illustrating another embodiment of blowing the tool tip 1T. In the example of FIG. 11, the refrigerant flow FA is directly blown from the nozzle 82 to the tool tip 1T. FIG. 12 illustrates an example in which the refrigerant flow FA is indirectly blown to the tool tip 1T via the workpiece 300. The tool 1 of FIG. 12 is provided with a tool tip blow unit 8A that blows the refrigerant flow FA to the workpiece 300.

The tool tip blow unit 8A includes the same refrigerant blower 80 and air supply pipe 81 as in the previous example, and an indirect nozzle 84 that blows the refrigerant flow FA to the workpiece 300. The indirect nozzle 84 is fixedly attached to a lower end of the air supply pipe 81. The indirect nozzle 84 has a tip opening 84T that blows the refrigerant flow FA at a predetermined intersection angle with respect to a surface of the workpiece 300. The indirect nozzle 84 is located at a position other than an advancing and retracting region of the tool 1 and does not interfere with the tool 1. The refrigerant flow FA blown from the tip opening 84T is once blown against the workpiece 300. After the above, the refrigerant flow FA is reflected by a surface of the workpiece 300 and is blown against the tool tip 1T. Therefore, the tool tip 1T is cooled and cleaned.

### SUMMARY OF PRESENT DISCLOSURE

The specific embodiment described above includes disclosure having a configuration below.

A friction stir spot welding device according to a first aspect of the present disclosure includes a pin, a shoulder having therein a first hollow portion into which the pin is inserted, and a clamp having therein a second hollow portion into which the shoulder is inserted and having, in a peripheral wall, a first hole for allowing refrigerant to flow into the second hollow portion.

According to the first aspect, since the first hole is provided in a peripheral wall of the clamp, refrigerant can flow from the first hole into the second hollow portion so that heat exchange can be performed directly between the refrigerant and the shoulder. Therefore, the shoulder can be efficiently cooled as compared with a case where the shoulder is indirectly cooled from an outer periphery of the clamp.

A friction stir spot welding device according to a second aspect is the device according to the first aspect, further including a nozzle attached to the first hole, in which the refrigerant is supplied to the second hollow portion through the nozzle.

According to the second aspect, by using the nozzle as a refrigerant supply port, refrigerant can be easily supplied to the second hollow portion.

A friction stir spot welding device according to a third aspect is the device according to the first aspect, further including an adapter with a supply hole which is closely attached to the first hole, in which the refrigerant is supplied to the second hollow portion through the adapter.

According to the third aspect, leakage of refrigerant from the first hole can be suppressed, and an amount of refrigerant supplied to the second hollow portion can be increased.

A friction stir spot welding device according to a fourth aspect is the device according to the first to third aspects, in which the clamp is arranged at a position different from the first hole, and further includes, in the peripheral wall, a second hole serving as a discharge path of refrigerant flowing into the second hollow portion.

According to the fourth aspect, refrigerant flow from the first hole to the second hole is formed in the second hollow portion. Therefore, heat exchange between refrigerant and the shoulder is promoted, and the shoulder can be efficiently cooled.

A friction stir spot welding device according to a fifth aspect is the device according to the fourth aspect, in which the first hole is arranged at a position higher than the second hole when a tip of the clamp is a lower end.

It has been confirmed by an experiment conducted by the inventors of the present disclosure that cooling efficiency of the shoulder is further improved by arranging the first hole serving as an inflow hole of refrigerant on the upper side and the second hole serving as a discharge hole on the lower side as in the fifth aspect.

A friction stir spot welding device according to a sixth aspect is the device according to the fourth aspect, in which the second hole is a material discharge hole for releasing a friction stir material entering between the shoulder and the clamp to an outside.

In a double-acting friction stir spot welding device, a friction stir material may inevitably enter between the shoulder and the clamp, and the clamp may include a material discharge hole for releasing the friction stir material. According to the sixth aspect, since the material discharge hole is used as a refrigerant discharge hole, it is not necessary to newly form a discharge hole in the clamp. Further, since refrigerant comes into contact with a friction stir material that enters between the shoulder and the clamp, the friction stir material can be cooled and discharged as an agglomerate.

A friction stir spot welding device according to a seventh aspect is the device according to the fourth aspect, in which the clamp includes, in addition to the first hole and the second hole, a material discharge hole for releasing a friction stir material entering between the shoulder and the clamp to an outside.

According to the seventh aspect, a friction stir material that enters between the shoulder and the clamp can be discharged from the material discharge hole. Further, since the second hole is provided separately from the material discharge hole, refrigerant flow from the first hole to the second hole can be stably formed.

A friction stir spot welding device according to an eighth aspect is the device according to the seventh aspect, in which a peripheral wall of the clamp includes a first region forming a tip of the clamp and having an inner diameter of a predetermined first length, a second region located above the first region and having an inner diameter of a second length longer than the first length, and an intermediate region located between the first region and the second region and compensating for a diameter difference between the first length and the second length, the first hole and the second hole are arranged in the second region of the peripheral wall, and the material discharge hole is arranged in the first region.

According to the eighth aspect, a space between an outer peripheral surface of the shoulder and an inner peripheral surface of the clamp becomes gradually narrower between the second hole, which is a discharge hole for refrigerant flow, and the material discharge hole. For this reason, the refrigerant flow is less likely to flow toward the material discharge hole, and is discharged exclusively from the second hole. Therefore, a friction stir material discharged from the material discharge hole is less likely to be cooled by the refrigerant flow, and solidification is suppressed. By this, a friction stir material can be discharged from the material discharge hole in a state of a mass having fluidity.

A friction stir spot welding device according to a ninth aspect is the device according to the fourth to eighth aspects, in which the clamp includes a region having thermal conductivity lower than thermal conductivity of the shoulder on a peripheral wall defining a path of the refrigerant at least between the first hole and the second hole.

According to a ninth aspect, a region having low thermal conductivity is provided on a peripheral wall between the first hole and the second hole of the clamp. For this reason, air heat around the friction stir spot welding device and heat of another portion of the clamp are less likely to be transferred to refrigerant flowing from the first hole to the second hole. Therefore, it is possible to realize a configuration in which most of cooling energy of refrigerant can be consumed for heat exchange with the shoulder.

A friction stir spot welding device according to a tenth aspect is the device according to the fourth to ninth aspects, in which the clamp includes a clamp tip portion forming a tip of the clamp and a clamp adapter to which the clamp tip portion is attached, the first hole and the second hole are provided in the clamp adapter, and the clamp adapter is made from a material having lower thermal conductivity than the clamp tip portion.

The clamp tip portion receives heat equivalent to the shoulder that performs friction stir. According to the tenth aspect, heat received by the clamp tip portion is less likely to be transferred to the clamp adapter, and as a result, it is possible to prevent refrigerant from being heated by friction stir heat.

A friction stir spot welding device according to an eleventh aspect is the device according to the fourth to tenth aspects, in which with respect to clearance between an inner peripheral wall of the clamp and an outer peripheral wall of the shoulder, when clearance between the first hole and the second hole is denoted by C1, clearance on a side farther from a tip of the clamp than the first hole is denoted by C2, and clearance closer to a tip side than the second hole is C3, relationships of

$$C 1 > C 2 and C 1 > C 3$$

are satisfied.

According to the eleventh aspect, by setting the relationships between the clearances C1, C2, and C3 above, refrigerant is likely to preferentially flow between the first hole and the second hole. That is, since the clearance C1 is set to be wider than the clearances C2 and C3, refrigerant is less likely to be released to a position above the first hole and to a position below the second hole. Therefore, heat exchange between refrigerant and the shoulder can be efficiently performed between the first hole and the second hole.

A friction stir spot welding device according to a twelfth aspect is the device according to the fourth to tenth aspects, in which with respect to a cross-sectional area of a space between an inner peripheral wall of the clamp and an outer peripheral wall of the shoulder in a direction orthogonal to a central axis of the clamp, when a cross-sectional area between the first hole and the second hole is denoted by SA1, a cross-sectional area on a side farther from a tip of the clamp than the first hole is denoted by SA2, a cross-sectional area closer to a tip side than the second hole is denoted by SA3, and an opening area of the second hole is denoted by SA4, relationships of

$$S A 1 > S A 2 , S A 1 > S A 3 , S A 4 > SA 2 , and SA 4 > S A 3$$

are satisfied.

According to the twelfth aspect, by setting the relationships between the cross-sectional areas SA1, SA2, and SA3 and the opening area SA4 described above, refrigerant is likely to preferentially flow between the first hole and the second hole.

A friction stir spot welding device according to a thirteenth aspect is the device according to the first to twelfth aspects, further including a refrigerant supply unit that supplies refrigerant to the first hole.

According to the thirteenth aspect, refrigerant can be stably supplied from the refrigerant supply unit to the second hollow portion.

A friction stir spot welding method according to the fourteenth aspect is a friction stir spot welding method using a tool including a pin, a shoulder having therein a first hollow portion into which the pin is inserted, and a clamp having therein a second hollow portion into which the shoulder is inserted, the friction stir spot welding method including allowing refrigerant to flow into the second hollow portion from a refrigerant inflow hole provided in a peripheral wall of the clamp.

According to the fourteenth aspect, it is possible to cause refrigerant to flow from the refrigerant inflow hole into the second hollow portion when the tool is operated, so that heat exchange can be performed directly between the refrigerant and the shoulder. Therefore, the tool can be operated while the shoulder is efficiently cooled.

A friction stir spot welding method according to a fifteenth aspect is the friction stir spot welding method according to the fourteenth aspect, in which inflow of the refrigerant is performed when the tool is driven. According to the fifteenth aspect, the shoulder can be cooled in a timely manner when the tool is driven.

### REFERENCE SIGNS

1 tool
11 pin
12 shoulder
12H first hollow portion
13 clamp
13H second hollow portion
131 clamp tip portion
132 clamp adapter
2 tool driving unit
30 overlapping portion
4 stirred and welded portion
51 first hole
52 second hole
53 material discharge hole (second hole)
6 nozzle
61 annular space
62 upper annular space
63 lower annular space
7 refrigerant supply unit
M friction stir spot welding device
F refrigerant flow

1. A friction stir spot welding device comprising:
a pin;
a shoulder having therein a first hollow portion into which the pin is inserted; and
a clamp having therein a second hollow portion into which the shoulder is inserted and having, in a peripheral wall, a first hole for allowing refrigerant to flow into the second hollow portion.

2. The friction stir spot welding device according to claim 1, further comprising a nozzle attached to the first hole,
wherein the refrigerant is supplied to the second hollow portion through the nozzle.

3. The friction stir spot welding device according to claim 1, further comprising an adapter with a supply hole which is closely attached to the first hole,
wherein the refrigerant is supplied to the second hollow portion through the adapter.

4. The friction stir spot welding device according to claim 1, wherein
the clamp is arranged at a position different from the first hole, and further includes, in the peripheral wall, a second hole serving as a discharge path of refrigerant flowing into the second hollow portion.

5. The friction stir spot welding device according to claim 4, wherein the first hole is arranged at a position higher than the second hole when a tip of the clamp is a lower end.

6. The friction stir spot welding device according to claim 4, wherein the second hole is a material discharge hole for releasing a friction stir material entering between the shoulder and the clamp to an outside.

7. The friction stir spot welding device according to claim 4, wherein the clamp includes, in addition to the first hole and the second hole, a material discharge hole for releasing a friction stir material entering between the shoulder and the clamp to an outside.

8. The friction stir spot welding device according to claim 7, wherein
a peripheral wall of the clamp includes a first region forming a tip of the clamp and having an inner diameter of a predetermined first length, a second region located above the first region and having an inner diameter of a second length longer than the first length, and an intermediate region located between the first region and the second region and compensating for a diameter difference between the first length and the second length,
the first hole and the second hole are arranged in the second region of the peripheral wall, and
the material discharge hole is arranged in the first region.

9. The friction stir spot welding device according to claim 4, wherein the clamp includes a region having thermal conductivity lower than thermal conductivity of the shoulder on a peripheral wall defining a path of the refrigerant at least between the first hole and the second hole.

10. The friction stir spot welding device according to claim 4, wherein
the clamp includes a clamp tip portion forming a tip of the clamp and a clamp adapter to which the clamp tip portion is attached,
the first hole and the second hole are provided in the clamp adapter, and
the clamp adapter is made from a material having lower thermal conductivity than the clamp tip portion.

11. The friction stir spot welding device according to claim 4, wherein
with respect to clearance between an inner peripheral wall of the clamp and an outer peripheral wall of the shoulder, when clearance between the first hole and the second hole is denoted by C1, clearance on a side farther from a tip of the clamp than the first hole is denoted by C2, and clearance closer to a tip side than the second hole is C3, relationships of
C1>C2 and C1>C3
are satisfied.

12. The friction stir spot welding device according to claim 4, wherein
with respect to a cross-sectional area of a space between an inner peripheral wall of the clamp and an outer peripheral wall of the shoulder in a direction orthogonal to a central axis of the clamp, when a cross-sectional area between the first hole and the second hole is denoted by SA1, a cross-sectional area on a side farther from a tip of the clamp than the first hole is denoted by SA2, a cross-sectional area closer to a tip side than the second hole is denoted by SA3, and an opening area of the second hole is denoted by SA4, relationships of
SA1>SA2, SA1>SA3, SA4>SA2, and SA4>SA3
are satisfied.

13. The friction stir spot welding device according to claim 1, further comprising a refrigerant supply unit that supplies refrigerant to the first hole.

14. A friction stir spot welding method using a tool including a pin, a shoulder having therein a first hollow portion into which the pin is inserted, and a clamp having therein a second hollow portion into which the shoulder is inserted, the friction stir spot welding method comprising:
allowing refrigerant to flow into the second hollow portion from a refrigerant inflow hole provided in a peripheral wall of the clamp.

15. The friction stir spot welding method according to claim 14, wherein inflow of the refrigerant is performed when the tool is driven.
